(19) United States
(12) Patent Application Publication
(10) Pub. No.: US 2016/0248825 A1
(43) Pub. Date: Aug. 25, 2016

(54) Registration-Free Location-Based Social Networks

(71) Applicant: Chian Chiu Li, Fremont, CA (US)

(72) Inventor: Chian Chiu Li, Fremont, CA (US)

(21) Appl. No.: 15/052,858

(22) Filed: Feb. 24, 2016

Related U.S. Application Data
(60) Provisional application No. 62/120,381, filed on Feb. 25, 2015.

(51) Int. Cl. H04L 29/06; H04L 12/24; H04L 29/08

(52) U.S. Cl. CPC H04L 65/403; H04L 67/18; H04L 41/0803; H04L 67/22

(57) ABSTRACT

Systems and methods for location-based social networks. Multiple social networks are configured for a place and a series of time slots respectively. In an aspect, a network is arranged accessible automatically to users who have been to a place at certain time. In another aspect, a network is arranged accessible for all online users. In yet another aspect, part of or all users of a social network are in invisible mode. Moreover, no registration is needed for network access.

### CROSS REFERENCE TO RELATED APPLICATION

This application claims the benefit under 35 U.S.C. Sec. 119 of provisional patent applications Ser. No. 62/120,381, filed Feb. 25, 2015.

### FEDERALLY SPONSORED RESEARCH

Not applicable

### SEQUENCE LISTING OR PROGRAM

Not applicable

### BACKGROUND

1. Field of Invention

This invention relates to social networks, and more specifically, to registration-free social networks based upon a place and arranged for a series of time slots respectively.

2. Description of Prior Art

A social networking system provides an online service, platform, or website that implements social networks, where users may share news, information, ideas, or feelings. A social networking environment is mostly web-based, and it enables users to interact with each other over the Internet, via online posts, instant or short messages, tweets, or emails.

Current social networks, social networking groups, or social networking circles are mostly constructed by connections, such as friendships, social relationships, family relationships, or common interest. A user may be represented by a profile containing personal info which is posted by the user and shared with other users of a network circle. In some cases, users of a circle may not know each other, but may be connected by common interest in a subject like a topic, product, event, or organization. Before joining a circle, a user would usually spend time gathering related info and then go through a registration process. In many cases, a user may not be able to join a network or circle directly. Instead, a user has to get an invitation from a current network member first or satisfy some qualification requirements. During registration, a user may submit certain personal information and obtain a user name.

As a result, current networks or circles have at least two major drawbacks: Limited networking range caused by personal connections and interests, and burdensome registration in each circle. The first drawback reflects the fact that it is hard for a user to reach beyond his or her present social environment. The second drawback comes from the redundant work during registration process in each networking circle.

From time to time, people have a desire to speak to others, or to know what other people talk about beyond own social circle. For instance, when a user is at a shopping mall, the user may want to exchange info with someone in there. When a user is at a train station, the user may want to know what happened when a train schedule is changed. Since conversations in a circle not closely attached to a user are mostly not critical, motivation to access it may not be strong. Consequently, some may give up and not visit such circle if there is a boring registration step.

Therefore, there exists a need for a virtual social network that doesn't demand personal connections, special interest, and registration process.

The word “post” as verb or “posting” is referred broadly as transmitting information from a user to a server via communication network to let others in a certain environment, such as a social networking circle, view the transmitted information. The word “post” as noun includes information posted or submitted by a user on the Internet, or user generated content on the Internet or in any network. Posted information or contents may cover a hyperlink or a uniform resource locator (URL), audio, video, an image, a text, a message, an e-mail, news article, blog entry, survey, etc. In practice, a user may or may not be allowed to post contents without registration, identification, or qualification. Posts are preferably hosted on a web site, but may also be hosted locally using local database or local server system.

The word “event” as noun is referred broadly as something happened or happening physically or virtually which may be witnessed or experienced by users. Examples include shopping, dining, gaming, travelling, commuting to and from work, service, a class in school, a concert or ritual, political, cultural, religious or sport activities, or other personal matters or collective behaviors.

### OBJECTS AND ADVANTAGES

Accordingly, several main objects and advantages of the present invention are:

a). to provide improved social networks;

b). to provide such social networks which don't need personal connections or certain interest to join;

c). to provide such social networks which are associated with a location and respective time slots;

d). to provide such social networks which utilize user's location records to allow access of network;

e). to provide such social networks which omit registration process;

f). to provide such social networks which allow an user to be invisible to others in a circle.

Further objects and advantages will become apparent from a consideration of the drawings and ensuing description.

### SUMMARY

In accordance with the present invention, methods and systems are proposed for social networks around a place for a series of time slots respectively. In one embodiment, being there at certain time is of the only condition to access a location-based network, while relationship with network member or interest in some subject is not needed. In another embodiment, all online users are granted access to a location-based network, without any requirement of location records. Moreover, registration procedures may be skipped for quick and easy network access. In addition, a user may choose to be invisible to other users or switch between visible and invisible modes.

### DRAWING FIGURES

FIG. 1 is an exemplary block diagram describing a user device embodiment in accordance with the present invention.

FIGS. 2, 3, and 4 are exemplary flow diagrams showing embodiments of social networking process in accordance with the present invention.

FIG. 5 is an exemplary flow diagram which illustrates management of social network in accordance with the present invention.

FIGS. 6 and 7 use exemplary flow diagrams to show embodiments of social network involving invisible users in accordance with the present invention.

FIGS. 8 and 9 use exemplary flow diagrams to show management of social network in accordance with the present invention.

### REFERENCE NUMERALS IN DRAWINGS

| | | | |
|---|---|---|---|
| 10 | Camera | 12 | Device |
| 14 | Processor | 16 | Computer Readable Medium |
| 18 | GPS Sensor | 20 | NFC Sensor |

100, 102, 104, 106, 108, 110, 112, 114, 116, 118, 120, 124, 126, 128, 130, 132, 134, 136, 138, 140, 142, 144, 146, 148, 150, 152, 154, 156, 158, 160, 162, 164, 166, 168, 170, 172, 174, 176, 178, 180, 182, 184, 186, 188, 190, 192, 194, 196, 198, 200, 202, 204, 206, 208, 210, 212, 214, 216, 218, 220, 222, 224, 226, and 228 are exemplary steps.

### DETAILED DESCRIPTION

The following exemplary embodiments are provided for complete disclosure of the present invention and to fully inform the scope of the present invention to those skilled in the art, and the present invention is not limited to the schematic embodiments disclosed, but can be implemented in various types.

A social networking environment may involve a networking system and multiple user devices. A networking system may contain multiple servers. User devices and network system are connected via communication networks. One or more social networks may be implemented by the networking system in the environment.

The word “server” means a system or systems which may have similar functions and capacities as one or more servers. Main components of server may include one or more processors, which control and process data and information by executing software, logic, code, or stored executable instructions, or carrying out any other suitable functions. A server and/or processor, as a computing device, may include any hardware, firmware, software, or a combination. In the most compact form, thanks to the advance of microelectronic technologies, a server may be built on a single processor chip.

A networking system may enable and implement various types of social networks serving a great number of users. It may exemplarily be divided into three blocks, represented by server, database, and router and switch. A server may comprise one or more servers processing applications, web applications, images, emails, networking, searching tasks, etc. The database may store data associated with users, networks, servers, and various services. Router and switch may transmit information packets between user device and networking system over communication networks and work as a gatekeeper to and from the networks. As social networks may involve a huge amount of data, which may be uploaded and aggregated by networking system continuously, a separate database system may be created. A database system may include a large number of storage devices or modules and specialty servers for data management and maintenance.

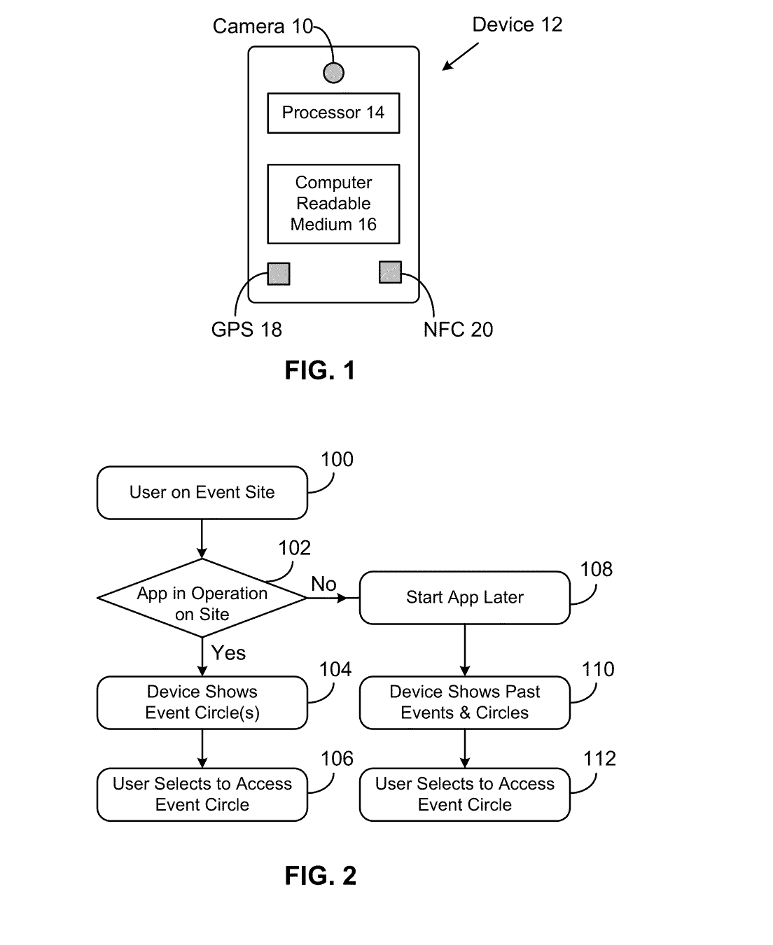

FIG. 1 is an illustrative block diagram of one embodiment according to the present invention. A device 12 may represent user device or a wireless electronic device, including but not limited to mobile phone, smart phone, smart watch, other wearable device, handheld computer, tablet computer, and the like. Device 12 may include a processor 14 and computer readable medium 16. Processor 14 may mean one or more processor chips or systems. Medium 16 may include a memory hierarchy built by one or more memory chips or storage modules like RAM, ROM, FLASH, magnetic, optical and/or thermal storage devices. Processor 14 may run programs or sets of executable instructions stored in medium 16 for performing various functions and tasks, e.g., surfing on the Internet, placing phone calls, logging on a website, playing video or music, gaming, electronic payment, social networking, sending and receiving emails, short messages, files, and data, executing other applications, etc. Device 12 may also include input, output, and communication components, which may be individual modules or integrated with processor 14. Communication components may connect the device to a server or another device via communication network. Usually, Device 12 may have a display (not shown in FIG. 1 for brevity reason) and a graphical user interface (GUI). A display may have liquid crystal display (LCD) screen, organic light emitting diode (OLED) screen (including active matrix OLED (AMOLED) screen), or LED screen. A screen surface may be sensitive to touches, i.e., sensitive to haptic and/or tactile contact with a user, especially in the case of smart phone, tablet computer, smart watch, and other wearable devices. A touch screen may be used as a convenient tool for user to enter input and interact with a system. Furthermore, device 12 may also have a voice recognition component for receiving verbal command or audio input from a user.

A communication network which device 12 may access may cover a range of entities such as the Internet or the World Wide Web, a local area network (LAN), a wide area network (WAN), a metropolitan area network (MAN), a telephone network, an intranet, wireless, and other types of networks. Device 12 may be connected to a network by various wired, wireless, optical, infrared, ultrasonic or other communication means. Via communication networks, device 12 may communicate with a remote server of networking system or service center to send and receive data or messages.

Device 12 may include a camera sensor 10. Sensor 10 may be a regular phone camera module used by user to take pictures in daily life. The camera sensor may be arranged to scan quick response (QR) code, one-dimensional barcode, or any other machine-readable code with the help of certain application. QR code or barcode may be printed out and displayed for public use easily.

Device 12 may include a global positioning system (GPS) 18. Sensor 18 may enable a device to get its own location info. Besides GPS, device location may also be obtained using wireless triangulation methods, or other suitable technology, which may be prepared by a service provider or on-site service facility. Usually for indoor or some urban environment, positioning methods other than GPS are used, since GPS requires a clear view of the sky or clear line of sight for four GPS satellites.

Furthermore, device 12 may have near-field communication (NFC) capability enabled by NFC sensor 20. NFC is of short-range wireless communication technology and may be employed to communicate securely with another NFC device. Sensor 20 may also be used to read radio-frequency identification (RFID) tag. RFID is also a wireless technology for the purpose of transferring data, such as identification data, passively or actively. A RFID or RFID tag may be made very small in size, e.g., smaller or much smaller than one millimeter. It may be manufactured by semiconductor technologies. In application, a RFID tag may be placed, for instance, on a table or wall conveniently.

Inside device 12, output signals of sensors may be transmitted to processor 14, which, employed with certain algorithm, may process the data and act according to predefined programs. For instance, processor 14 may process data from NFC sensor 20, transmit certain messages to a networking system or service center, and then waiting for instructions or new messages from the system or center.

FIG. 2 is a schematic flow diagram showing one embodiment of social networking process. Assume that a user is on the site of an event in Step 100. The site may be of a subway station, a store, or a building on a college campus, corresponding to events like commuting, shopping, or education respectively. A social networking circle may be arranged for each event by networking service center. The circle is based on a site or location and a time period or time slot. For instance, a circle may be built for a subway station between a period defined by a starting time and an ending time. Every user who visited the station during the time period is eligible to access the circle. In other words, being there in certain time slot is of the sole qualifying condition for a user to access a circle. To make life simple, no registration is needed in the process. A circle prepared for an event may also be called event circle. In Step 102, the first question is whether a social circle app is started at user device. The app may be designed by networking service center or a software company for implementing location-related social networks, which may collect location info of user device and send location records to service center. Service center then may determine whether there are any event and event circle suitable for the user. If a social circle app is on, in Step 104, available event and event circle are presented on a screen of user device. The app may work as a networking platform for user to participate in social networking activities. There may be multiple circles arranged for multiple events at a location in one time slot. For instance, there may be multiple subway platforms at a subway station, where each subway platform may support a social circle; and there may be multiple retail stores at a shopping center, where each store may have its own social circle. On the other hand, multiple circles may be arranged at a place for different time slots respectively. Back to Step 104, where one circle or multiple circles may be presented on user device. Then in Step 106, a user may select a social circle, e.g., via clicking or tapping a circle icon on screen. It may be arranged that no password or registration is required to log in a social networking circle. After clicking or tapping a circle icon, a user may enter the circle directly. Next, a user may read posts submitted by other circle members as well as post his or her comments. If a site is of one or more subway cars of a formation, it means a user may start communicating with fellow passengers.

When circle app is not launched on site, a user may still be eligible to access an event circle, if service center has user's location records, i.e., data on where and when a user has been. Proper location records may be used as a proof to show a user visited a site at certain time or registers an event. “Register” as a verb means a user enables submission of location records actively or passively to provide evidence of event attendance. After service center receives a user's location records and finds a corresponding event, it may be considered that the user has registered the event. For instance, a user may open a circle app, and scan a QR code displayed on event site to register an event. After a QR code is scanned, circle app may be programmed to extract event and/or location info and send service center a message confirming user presence on a site at a time. After a user registers an event, the user may be qualified to access an event circle instantly. Service center may be equipped with servers and database which may collect and record sites visited by subscribing users. The center may allow access of networking circle for eligible users on site, or make the circle open to eligible users for a given time period. Assume that a circle app is started later at user device in Step 108. Next, the user device may receive messages from service center via communication networks, and in Step 110 device display may show events and event circles which represent present and past activities a user is involved with. Then in Step 112, the user may pick a social circle and join discussions there. It is noted that past events may be as attractive as an ongoing one to users, since at least people in the circle have some common experience, and may have similar opinions toward an event issue. Thus any event, whether in developing stage or concluded already, may be used to configure a social circle, where people may post info, communicate with each other, or just read comments made by others.

It is noted that password and registration process are omitted for accessing social circle. After a user starts a circle app, the app, as a networking platform, may display a list of circles available on an interface. These circles are arranged open or accessible to the user. A user may access contents of any of the circles directly, e.g., by clicking or tapping on an on-screen circle icon or button, assuming that the screen is touch sensitive.

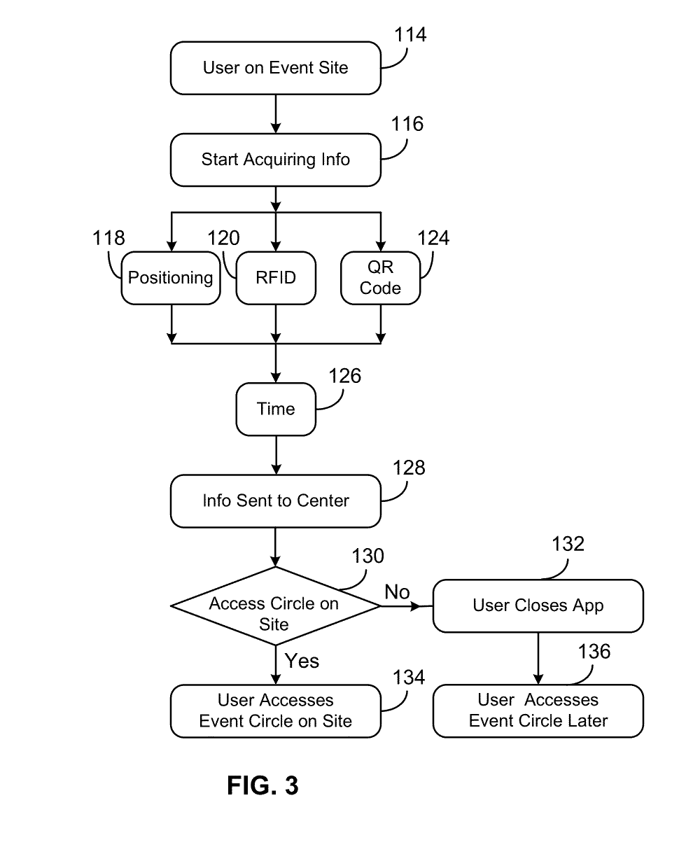

FIG. 3 shows another schematic flow diagram of social networking process. Assume that a subscribing user is on an event site in Step 114. Next, a user device, service carrier, or on-site facility may start to collect location and time data in Step 116. Depending on program setting, a user may register an event via different ways, since there are multiple technologies for detecting user location.

In Step 118, positioning technique such as GPS or triangulation methods is used to get user location automatically and directly. GPS method requires a GPS sensor, such as sensor 18 of FIG. 1, while triangulation method may be conducted by on-site facility or wireless service carrier.

In Step 120, RFID technology is used. A RFID tag may be displayed at the scene of event. If a user device has a NFC sensor, like sensor 20 of FIG. 1, a user may place the device close to a RFID tag to read it. A RFID tag may contain event info so that it may enable a user device to get qualified and logged in a social circle directly. Alternatively, a RFID may be designed as a location indicator, that is, the tag only provides location info and thus may be used for all events related to the location.

Step 124 introduces QR code method, which works in a way similar to RFID. The code may contain info of a particular event or info of a location only. As a location indicator, RFID tag and QR code may provide precise geographic information. They are especially useful when positioning method is not available, not preferred due to privacy concerns, or not precise enough. But RFID and QR-code methods are not automatic and they require a user to take action, either swiping a device in front of a tag or aiming at and scanning a code.

In Step 126, the time when a user is on site is recorded. Time info may include a period during which a user remains on site, or just the time when location info is recorded. As several events may take place at a location at different times, like different ball games at a sport venue, or consecutive event sessions on a site, time info is an important factor for matching an appropriate social circle. For instance, a train station may have several social circles designed around it for multiple time lots.

Once a user's location and time info is obtained, it is sent to service center in Step 128. The center then decides which event to select and which social circle should be arranged open to the user. Next service center sends a message to user device with a list of events which are relevant to the user and a list of eligible social circles. In Step 130, a user may decide whether to visit an event circle while still on site. If there is more than one circle prepared for a user, the user may choose one circle, and access it in Step 134. If the user is busy, he or she may close circle app in Step 132. And later in Step 136, the user may launch the app and access a circle, which has become a network of a past event. It may be designed that a user may be allowed to log in a social circle and post contents within a given time period starting from the end point of time slot, say a week, a month, or no longer than two months. After the given time period elapses, the circle may become inactive and the circle or network may be considered expired. After a circle expires, a user may still find it and log in it, but may not be able to post anything in it. For expired circle, its records of past post may be kept and open to eligible users for a certain time period.

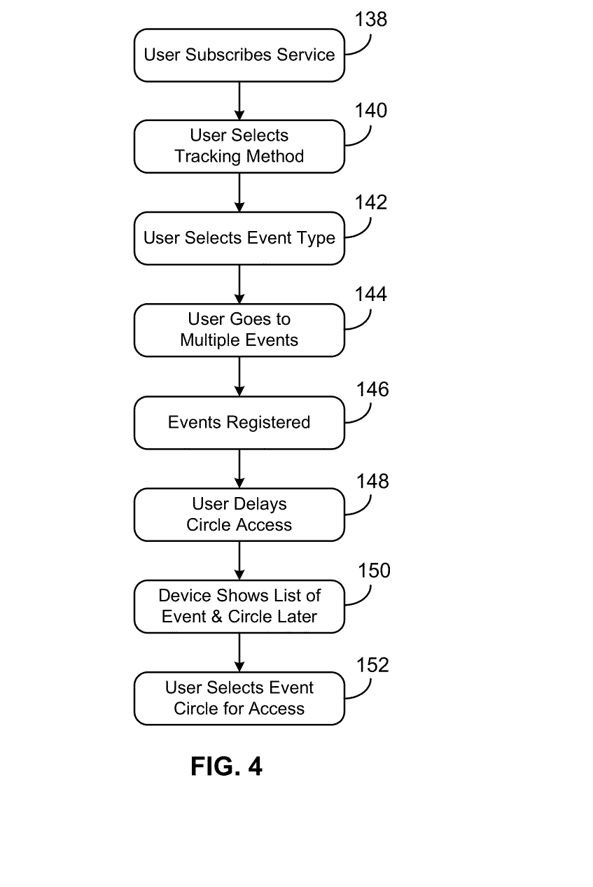

FIG. 4 shows an exemplary flow diagram of social networking process from another angle. In order to join a location-based social networking circle, a user may start by opening an account or subscribing networking service at service center in Step 138. A circle app may be downloaded from the website of service center and installed at user device. During app installation, a user may be asked to submit info such as name, place of residence, and preferred user name. As a result, service center may know a user's identity and other personal info, and thus may be able to help the user log in a social circle without another round of registration process and without password. Consequently, a user may carry a user name registered at networking service center and use it in participating social circles. The arrangement makes a social circle free of registration and in the meantime, a user doesn't need to create user name for every circle interested.

In Step 140, a user may select options of tracking scheme. As location data is a critical part of the program, a user may decide which detection method would be employed. As location data contains sensitive information, some users may be concerned about privacy issues. For instance, some may not want service center to know all places he or she has been to. In such a case, automatic position detection like GPS and triangulation should be turned off, while manual operation such as RFID and QR code may be selected, which means location records are collected and reported only when a user permits it. In practice, a user may place a user device close to a RFID tag to read it, or arrange a camera to aim at a QR code to scan it. When GPS method is selected and GPS device is turned on, a circle app may acquire location info and send location records to service center automatically, assuming the circle app is started already. Service center may analyze user's location records and retrieve matching event and event circle. The event and circle info may be transferred to user device instantly. If triangulation or other positioning technology such as ultrasonic method is selected, user's location records may be collected and sent to service center automatically as well, still assuming a circle app is on. When a circle app is off and a user arrives at an event, a user device may not communicate with service center and submit or help submit location records. But a user may authorize service provider or service facility to collect his or her location records and transfer the records to networking service center. Thus whether a circle app is on or off, events may be registered automatically. A user may also preselect certain places, so that only location records of these places may be sent to networking service center automatically.

In Step 142, a user may select event type of interest. As many event circles may exist, like commuting train circle, shopping mall circle, public venue circle, a user may have a long list of social circles presented on user device at a time. The user may like some social circles and dislike some other circles. Thus there is a need to avoid registering some events and limit the quantity of social circles in daily life. A user may delist a category of event, like all events related to a college if the user is just a passerby, or cancel all events related to a particular place or activity. After an event is cancelled, circles around the event may be withdrawn from a user account.

As a user goes out in Step 144, commuting to work or doing things at places, he or she may encounter certain events here and there. The user may register those events in Step 146. Events may be registered after user location is detected via aforementioned means automatically or manually.

In Step 148, a user may want to access a social circle at a later time, instead of on site. When positioning method is used, a circle app may not need to be launched or in a standby state. If RFID or QR code method is used, a user may have to turn on a circle app. But the user may opt for hooking up with a location or an event only, without entering or accessing a circle, even though circle contents are already accessible.

In Step 150, a user device presents a list of events at a later time, along with event circles which are open to the user. Next in Step 152, a user selects one circle from the list and starts reading circle contents.

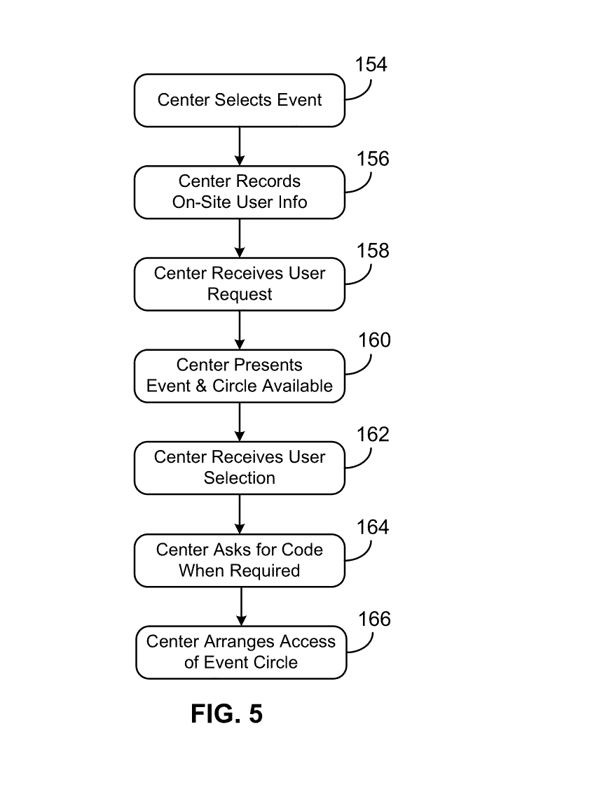

FIG. 5 shows a schematic flow diagram of social network formation and administration. Assume networking service center is in charge of social network management. Service center may get connected to user device via various communication networks. As a great number of events may exist, it is up to service center to decide which one shall be chosen for creating event circle. As in Step 154, service center selects events and announce creation of event circles. Event circles are publicized and arranged accessible online to eligible users. At an event location, subscribing users may register event, and location records may be sent to service center and get recorded there in Step 156 for present and future use.

In Step 158, the center receives request for event and circle information from user, which may happen after a user launches a social circle app. Then in Step 160, the center sends a list of events and social circles for presentation on user device. Next in Step 162, the center receives selection info from the user, who may want to access a circle from the list. Step 164 is an optional procedure, which asks a user to submit a code as a condition for circle access. Such request is desirable when a social circle is arranged for pre-selected users only. At last, the center arranges circle access for the user in Step 166. After that, the user starts participating in activities of the social circle.

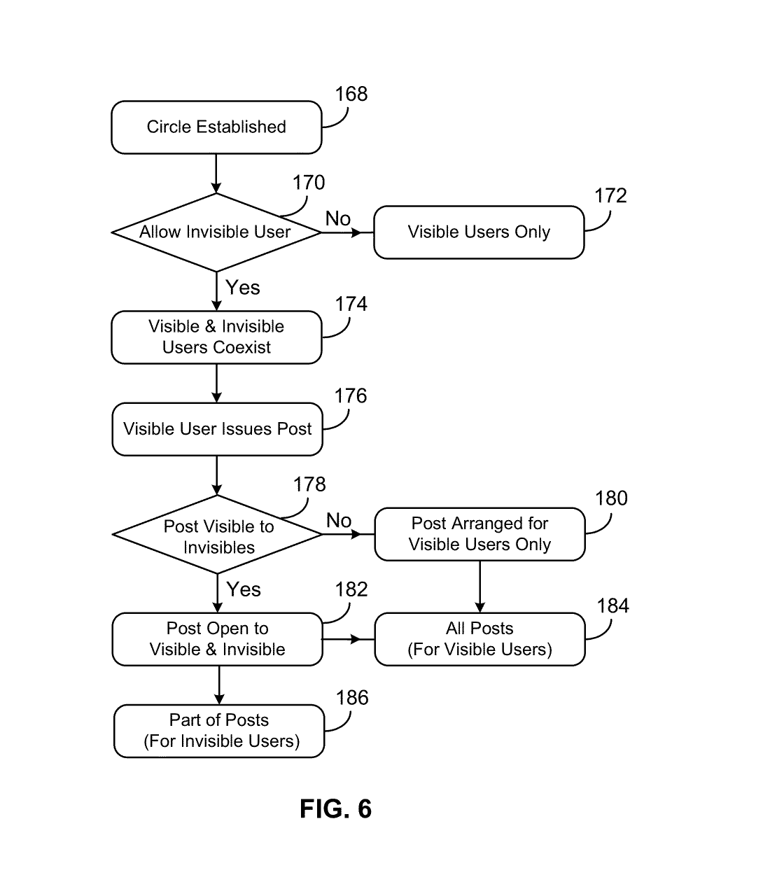

FIG. 6 shows a schematic flow diagram to illustrate another kind of social networking circle. In current social network, personal connections play an important rule. A user may know most members of a circle, or know a common interest which supports a circle. In such scenario, everyone is visible and enjoys the same right to post contents and view other's post. The word “visible” may mean user names of circle member are listed on a circle page so all members may view it. For instance, if a user is visible in a circle, his or her user name may be displayed on a list from a circle page so all circle members can see it. On the contrary, the word “invisible” may mean a user's user name is not publicized in a circle. If a user is invisible in a circle, the user's name does not appear on a member list. Thus circle members are not able to see the name of an invisible user and not able to know whether an invisible user is in the circle. When a user is visible or invisible in a circle, the user may be considered in visible or invisible mode respectively. The word “mode” means a status or state of user when the user is in a circle. For location-based social circle, there are users who had registered an event and are eligible to access circle contents, but never logged in. These users can't be categorized as circle member. Only after a user accesses circle content or logs in a circle, the user may be considered as a circle member. Once a user becomes a circle member, his or her user name may be added to a member list of the circle. Thus in current social circle, circle members know the names of other members. Exposing user name in current social circle does not cause any issue so far.

However, a location-based social circle is different, where most people are unknown and may remain that way. As a consequence, some users may just want to take a look at posts and don't want to be seen by others in a circle, because after all, a user may never know who is who showing up there. Thus, there exists a need to be invisible in a circle. Invisible users in a circle don't expose their user name, even though a user name is not a real name. It may be designed that an invisible user may or may not be allowed to post contents in the circle. In the former scenario, a circle may appear similar to current circle except some members are invisible. Both visible and invisible users may have equal access to information posted in a circle, and both may post contents. Invisible user's post may or may not carry a user name, or may carry a name temporarily assigned to avoiding exposing identity depending on rules set for a circle. For practical need, it may be arranged that a user may switch between visible and invisible mode. In the latter case, invisible user may not be allowed to post anything, as posting right may be reserved only for visible users to encourage users to show up in a circle. Furthermore, visible user of a circle may have the option to decide whether his or her post is available to the invisibles, as a user may prefer limited audience. The following is focused on the latter case.

Assume a social circle is set up by service center in Step 168. In Step 170, decision is made about whether invisible mode or invisible users are allowed. If invisible users are prohibited, Step 172 is carried out. The social circle contains visible users only, who share the same right.

If invisible users are allowed, the social circle comprises two types of users: Visible and invisible, as shown in Step 174. It may be arranged that invisible users may only view certain posts and may not issue a post, while visible users may view all posts and issue posts. In Step 176, a visible user publishes a post. The user may determine whether the post is viewable to invisible users in Step 178. If the user doesn't want to include the invisibles, his or her post becomes viewable to visible users only in Step 180.

If the user makes the post available to all users, the post becomes accessible to both visible and invisible users in Step 182. And then the post is added to a list of posts which are open to invisible users in Step 186. Meanwhile, all posts generated in the circle are collected and made accessible to visible users in Step 184.

As invisible user has almost nothing to expose or lose, it may attract conservative and wary users who may otherwise stay away from a social circle full of unknown people or strangers. A larger audience base, even invisible, may be an encouraging factor for some posters who enjoy attention in a circle. Also for such a reason, it may be arranged that the total number of invisible user or invisible member in a circle may be displayed on a circle page or in a circle interface. When an eligible user logs in a circle in invisible mode, the user may be arranged to become an invisible member of the circle automatically. As the numbers of visible and invisible users in a circle reflect the degree of user involvement, popularity of a circle may be presented without compromising user privacy.

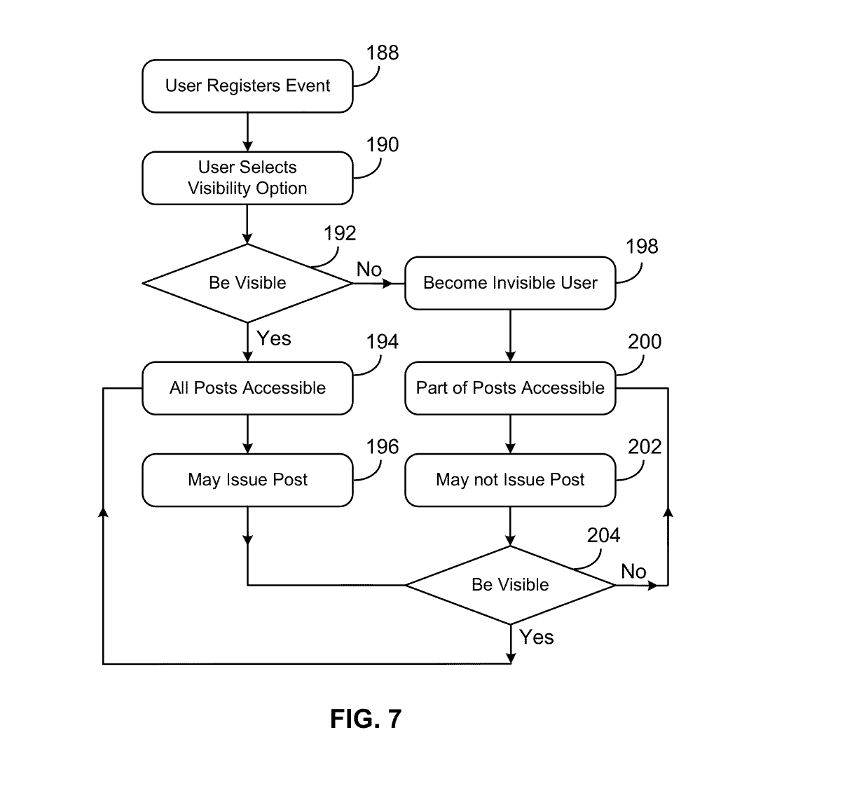

FIG. 7 depicts another schematic flow diagram of social circle involving invisible users. In Step 188, a user arrives at a location and registers an event automatically or manually. Assume that a circle app is on and a corresponding event circle appears on a touch-sensitive screen of user device. From communications with the circle app, service center may know the identity of user. Thus, access of social circles may be arranged straightforward and password-free. Returning to the flow diagram. In Step 190, the user decides to enter an even circle and starts to select visibility option. An interface of social app may show an on-screen object representing the event circle. Two check boxes may be placed beside the circle object with labels “Be Visible” and “Be Invisible” respectively. For instance, a user may check “Be Invisible” box and then tap the circle object. Next the user may log in the circle in invisible mode, which may come with full or limited capacity depending on rules of a circle. The user may also select “Be Visible” box and tap the circle object to enter the circle in visible mode with full privilege. When no box is selected, it may be assumed that a user prefers visible mode. According to user selection, Step 192 sends user to different routes. If a user chooses visible mode, the user becomes visible to others and may view all posts published in the circle in Step 194, and may be able to issue post in Step 196.

If a user doesn't want to be seen in a circle, the user becomes invisible to others in Step 198. Then the user may only read posts which are arranged for the invisibles in Step 200, and may not view other posts. Furthermore, the user may not post anything as indicated in Step 202. It may be designed that a user may switch between visible and invisible modes. Step 204 provides such an opportunity. In Step 204, a user may convert from visible mode to invisible mode, from invisible mode to visible mode, or maintain the status quo. For instance, a user in invisible mode in Step 202 may switch to visible mode in Step 204 and then go the Step 194 to view all posts. On the other hand, a user in visible mode in Step 196 may take invisible mode in Step 204 and go to Step 200, where only part of the posts are accessible. It may be arranged that a user may switch from one mode to the other mode multiple times.

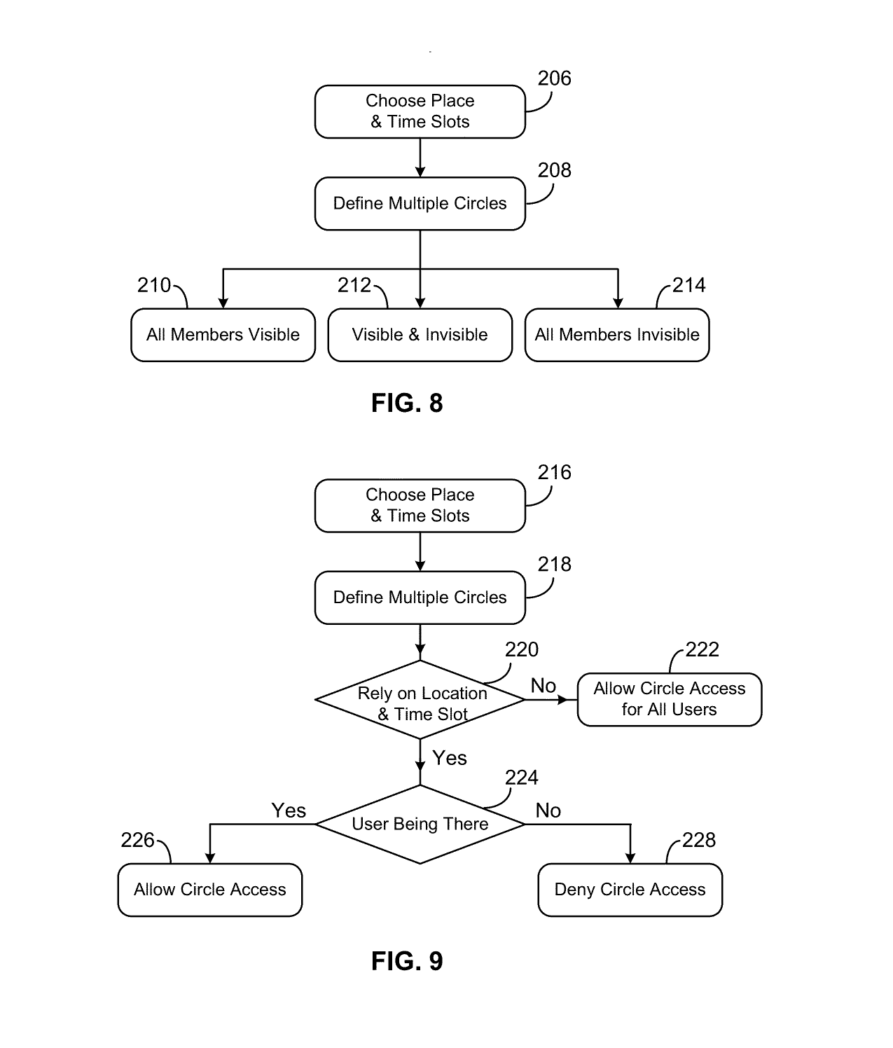

A basic overview of location-based network schemes is illustrated via an exemplary flow diagram in FIG. 8. The objective is to create a group of social circles. First, a place is chosen and time slots are decided in Step 206. For instance, target place may be a shopping mall. There may be ten time slots covering ten hours ranging from 10:00 am to 8:00 pm. Each time slot is a one-hour interval. The first slot starts at 10:00 am, the second at 11:00 am, and the last at 7:00 pm. In Step 208, social circles are defined for each time slot. For instance, a first social circle is based upon the shopping mall and the first time slot from 10:00 am to 11:00 am. As discussed before, it may be designed that all users who visit the mall in the first time slot may be granted access to the first circle automatically. If a circle app is turned on, a user may register the event, i.e., getting detected at the mall in the first time slot, via automatic method like GPS or triangulation or manual method like RFID or QC code. Then the user may access the first social circle on site or at a later time. When a circle app is not on, user's service provider may sense the location of user device. If it is detected that a user is at the mall in a time slot, the user may qualify to access a matching circle. The user may be allowed to enter the circle within a given time period.

One feature of location-based social circle is that it is about a place and a time slot. A location-based circle may be defined by a place and a time slot only, or its creation is solely dependent upon a place and a time slot, while current social circle is determined by a subject or event. Take a downtown square for instance. When square-based circles are arranged, what would happen on the square is not a concern, since many activities may take place there, some known in advance and some remains unknown until it happens. But when a current social circle is planned, the focus is on event, where place and time are secondary factors. For example, when a concert would be held at the downtown square, a social circle may be built around the concert, not the square.

Another feature of location-based social circle is that it is often recurrent or a group of social circles are arranged to be recurrent collectively. Still take the shopping mall for instance. The ten social circles arranged for the mall, corresponding to ten time slots, may be scheduled to emerge consecutively every day in a period of time, like a year, since the mall may be open every day during that time. It also means no matter what time a user goes to the mall, he or she knows there is a social circle to join. On the contrary, current event-based circle is a one-time-only phenomenon.

A third feature of location-based social circle is that it usually comes as a group of circles, not just a single one. Above shopping mall example shows ten circles designed for ten time slots. As users move around in daily routine, most may stay at a place for a brief time period only. Since a social circle is configured for people with similar experience, and different things may happen at different times, it is necessary to use time slot to assign users to respective circles. Thus users in a circle may have some experience in common and contents posted in a circle may be more relevant. Therefore multiple social circles designed for a place fitting a series of time slots are clearly different from current social network which usually doesn't use time as an enrolment condition.

Back to the flow diagram. In Steps 210, 212, and 214, visibility issue is addressed for social circle. Step 210 reflects the current situation, where all users are visible to each other and have the same right. It may also be designed that all users are invisible as in Step 214. When all are in invisible mode, there is no chance to be visible or switch to visible mode. Thus no one knows who is in the circle except service center. But when a user posts comments or certain contents, his or her name may be attached and exposed. A name with a post may be a user name assigned by service center or a pseudo name assigned for temporary use depending on rules applied. Step 212 shows a scenario where both visible and invisible users are allowed, which is introduced already, such as in discussions on embodiments of FIGS. 6 and 7. When both visible and invisible modes exist in a circle, switching between modes may be allowed.

FIG. 9 uses another schematic flow diagram to show embodiments of location-based social circles. Steps 216 and 218 are similar to Steps 206 and 208. Before setting up social circles, a place is selected and a group of time slots are chosen for a group of circles respectively. Creation of social circles around a place may be made public so that users know the existence of circles and may get prepared to utilize them. As a location-based social circle may repeat itself each day, at the same place and in the same time slot, there may be numerous circles established by service center. In addition, location-based circle is about routine event, which may lose attention quickly in most occurrences. Thus service center may define an expiration date for each circle before a circle is created and let users be aware of it. After expiration, users may not be allowed to do posting in a circle, but may still log in it to view previous posts, depending on terms and conditions prearranged. Compared with current social networks, location-based social circle not only has an expiration date assigned early on, but also keeps a relatively short operational period. For instance, current networks may be in operation for years or last as long as an owner likes. But location-based social circle may be arranged in operation for a much short time, say a month, or a period no longer than two months. Members of location-based circle are strangers anyway and a location-based event may repeat daily, without anything special most time. Thus it might be unnecessary to keep a location-based circle running for a long time.

When configuring a location-based circle, service center may decide whether to use location and time data as the requirement for enrolment or access, as shown in Step 220. If location and time are needed for circle access, user's location records may be examined by service center to ascertain whether a user has been there in Step 224. In practice, after a circle app is launched, the app may communicate with service center, informing of user identity and helping submitting location records. If location records show a user visited there in a time slot, he or she may be permitted to access a circle in Step 226. When records don't have adequate evidence, a user is denied circle access in Step 228 or the event circle won't appear in app interface.

As a location-based circle is full of unknown users, any private or exclusive info may hardly get involved. On the other hand, some of the recurring social circles may become well known in local community after a while. As no one's interest may be affected and many already know its existence, some location-based social circles may be designed to be open to the general public, all online users, or all users as long as they can access the Internet or access a circle website. Step 222 describes such situation. To access an open-to-public circle using circle app, a user may search the circle name, get info from service center, and then log in it. A user may also access an open-to-public circle without circle app. For instance, a user may do a search to retrieve info of a particular circle, find its website address, and then log on its web page.

It is noted that the embodiments and schemes introduced in above discussions regarding FIG. 9 applies to social circles comprising visible users only, invisible users only, or a mixture of visible and invisible users.

### CONCLUSION, RAMIFICATIONS, AND SCOPE

Thus it can be seen that systems and methods are introduced to provide improved social networks.

The improved method and system have the following features and advantages:

(1). Multiple social circles are created for a location and a series of time slots respectively;

(2). Users may be granted circle access based on location records only;

(3). Location data may be obtained by position measurement, RFID, or QR code method;

(4). Registration may not be required for circle access;

(5). Social circles may contain invisible users;

(6). Social circles may be arranged open to all online users.

Although the description above contains many specificities, these should not be construed as limiting the scope of the invention but as merely providing illustrations of some of the presently preferred embodiments. Numerous modifications will be obvious to those skilled in the art.

### Ramifications:

Because location-based social circles enable instant on-site posting, some users at the scene may feel offended or even threatened by certain comments of other users. To avoid embarrassment and provide a safe environment, a circle function may be added which may allow any user of circle, visible or invisible, to freeze a circle and delete a post. For instance, when a careless user issues a rude post in a circle, another user may stop it by activating a button, such as an on-screen button with a “Freeze” label in a circle interface. The button may be designed to suspend posting activities in a circle and delete a post which a user deems to be inappropriate. For instance, a user may select a post and then tap “Freeze” button. After that, the post may be deleted from the circle and posting act may be prohibited for a given period of time, say five minutes. Once suspension period ends, the circle may resume regular functionality. Alternatively, two buttons may be arranged, one for stopping the function of posting temporarily, and the other for deleting a post. It may be designed that after a user taps a button to delete a post in a circle, a server at service center may execute the deleting job. After a post is removed from circle, a user may not receive or see the post when the user accesses the circle. But users who already received the post may still keep it.

A user may speak to a device to enter instructions using voice recognition techniques. For instance, a user may say “circle app” to a device to open a circle program. Next the user may take a look at a circle list presented on screen, and say a circle name to enter a circle.

When visible and invisible users coexist in a circle, one option is that invisible users may not be allowed to issue post and may only access part of the posts generated by visible users in a circle, which is illustrated schematically in FIGS. 6 and 7. Another option is that invisible users may not have the right to post, but may view all contents posted in a circle. So compared to visible user, an invisible user may have the same viewing right, but lack the chance to post contents in such circle design.

Step 222 describes a social circle that is open to the public, which means all online users may access it without password, registration, and location records. In some cases, people may want to keep a social circle in local area. Thus a circle may be designed to allow access for users in one region only. For instance, only users who have been to a city in a time period or users who have been to a city multiple times may be allowed to access a circle. On the other hand, it may be arranged that all users who subscribe social circle service or have a circle app installed and operable at his or her device may have access to certain circles. Such social circle is designed to be accessible to all subscribing users who have an account at service center, but be closed to the general public.

When an event circle is open to users who have not been to an event, it may be designed that only qualified users may post contents, where the qualification requirement may be of being there in a time slot. The reason is that event circle may lose its appeal if a lot of posts are made by outsiders or users unrelated to the event. For similar reason, when all users are allowed to post in an open-to-public circle, marks may be arranged to indicate whether a post is made by a user who has been to an event. For instance, stickers like “Member” and “Non-Member” may be prepared. “Member” means a user who has been there at certain time, while “Non-Member” means an outsider who has not being to an event at certain time. When a user is not a subscriber of service center, the user may not have location records available. As a consequence, an unknown or unregistered user may be labeled as “Non-Member” regardless of his or her actual experience. The two stickers may be attached to posts in a circle so that it is easy to tell which post comes from event participant and which is generated by nonparticipant or unrecognized user.

As discussed in FIG. 5, service center may decide which event circle should be arranged. In real life, service center may not know all needs of users. Thus, users, especially business and organization entities, may request service center to create an event circle. Then service center may investigate it, approve the request, and set it up. For instance, a store may want to establish a circle of its own. In such a case, the store may also want to specify conditions for user to join a circle and methods a user may use to register an event. The purpose of defining conditions and registering method is to make sure only qualified users such as people who visited the store may register an event. Meanwhile, the store may prepare RFID tag, QR code, and capable and convenient positioning method for users. Besides business and organization, an individual user may also request to arrange an event circle. For circles originated from request outside of service center, a label such as “Sponsored Circle” and the name of originator may be shown in a circle interface. Display of the label and originator name may be mandatory since the circle may be used for the advantage of certain group or person. Service center may collect fees for creating and maintaining such circles.

When an event circle is created upon the request of a business, organization, or individual, an originator may want to stay in the circle permanently or become a permanent member. “Permanent member” means a member who may remain in recurrent circles without showing presence at a place in recurrent time slots for a given period of time. For instance, if a user is a permanent member of a circle designated for a place and a time slot, the user may access not one circle but all recurrent circles which are created for the place and recurrent time slots along a time line without providing location records. Besides, any business or organization which is related to an event place may apply to become permanent member at service center. Service center decides whether to grant permanent membership to an entity. A permanent member may be in visible or invisible mode. When the name of permanent member appears in a circle, such as on a user list or with a post issued, a label like “Permanent Member” may be attached to distinguish the user from other members. When a permanent member represents a business or organization, its user name may be arranged to reflect the business or organization explicitly so that other users know it does not represent an individual.

Location-based social circles may be arranged for drivers and passengers in an automobile as well. For instance, a subscribing user may select positioning method, such as GPS or triangulation, to detect his or her location and let measurement data be transferred to service center instantly. Service center may use the data to register event for users. From position data, user's moving patterns may be derived. So service center may find out whether a user is walking or in a vehicle at certain speed and then assign the user to a suitable event circle.

Lastly, in aforementioned discussions, QR code may be replaced by other machine readable code without affecting proposed functionality, such as one-dimensional bar code, as long as the code contains info required and is readable by user device.

Therefore the scope of the invention should be determined by the appended claims and their legal equivalents, rather than by the examples given.

1. An apparatus having stored executable instructions, comprising:
1) at least one computing system being operable to implement a social networking system, said social networking system arranged to implement a plurality of social networks, said plurality of networks arranged to be associated with a predetermined location, said plurality of networks related to a plurality of time slots respectively, one of said plurality of networks arranged open to a user based upon location records of said user;
2) said location records of said user related to said location and one of the time slots; and
3) said plurality of social networks arranged such that contents of said one of said plurality of networks become accessible to said user after said user activates an on-screen icon representing said one of said plurality of networks on a platform system, said platform system arranged operable at a user device.

2. The apparatus according to claim 1 wherein said location records are acquired automatically by positioning method.

3. The apparatus according to claim 1 wherein said user is arranged in invisible mode in said one of said plurality of networks.

4. The apparatus according to claim 1 wherein said one of said plurality of social networks is arranged such that said user has options to switch between visible mode and invisible mode in the network.

5. The apparatus according to claim 1 wherein implementation of said plurality of social networks is arranged to recur along a time line.

6. The apparatus according to claim 1 wherein said plurality of social networks is arranged such that posting act becomes unavailable for each network after a given time period elapses.

7. The apparatus according to claim 1 wherein said one of said plurality of social networks is arranged such that all users are in invisible mode in the network.

8. A computer-implemented method, comprising:
1) configuring a plurality of social networks using a networking system;
2) said plurality of networks arranged to be associated with a predetermined location, said plurality of networks related to a plurality of time slots respectively;
3) obtaining location records of a user;
4) arranging one of said plurality of networks open to said user based upon the location records of said user; and
5) making contents of said one of said plurality of networks accessible to said user after said user activates an on-screen icon representing said one of said plurality of networks on a platform system, said platform system arranged operable at a user device.

9. The method according to claim 8, further including acquiring location records automatically via positioning method.

10. The method according to claim 8, further including arranging said user in invisible mode in said one of said plurality of networks.

11. The method according to claim 8, further including providing options for said user to switch between a visible mode and invisible mode in said one of said plurality of networks.

12. The method according to claim 8, further including arranging said plurality of social networks to be recurrent along a time line.

13. The method according to claim 8, further including suspending posting activities in each of said plurality of social networks respectively after a given time period elapses.

14. The method according to claim 8, further including arranging all users in invisible mode in said one of said plurality of networks.

15. A computer-implemented method, comprising:
1) configuring a plurality of social networks using a networking system;
2) said plurality of networks arranged to be associated with a predetermined location, said plurality of networks related to a plurality of time slots respectively; each of said plurality of networks generated based solely upon said location and one of said plurality of time slots; and
3) arranging contents of one of said plurality of networks accessible to a plurality of users when said plurality of users visits said one of said plurality of networks respectively.

16. The method according to claim 15, further including determining the location of said plurality of users and allowing access of said one of said plurality of networks for users related to a predetermined region only.

17. The method according to claim 15, further including providing options for said plurality of users to switch between a visible mode and invisible mode in said one of said plurality of networks respectively.

18. The method according to claim 15, further including arranging said plurality of social networks to be recurrent along a time line.

19. The method according to claim 15, further including suspending posting activities in each of said plurality of social networks respectively after a given time period elapses.

20. The method according to claim 15, further including arranging all users in invisible mode in said one of said plurality of networks.
